(19) United States
(12) Patent Application Publication
(10) Pub. No.: US 2024/0408676 A1
(43) Pub. Date: Dec. 12, 2024

(54) DETERMINING QUALITY OF REUSED BUILD POWDER FOR ADDITIVE MANUFACTURING

(71) Applicant: Raytheon Technologies Corporation, Farmington, CT (US)

(72) Inventors: Jesse R. Boyer, Middletown, CT (US); Brian A. Fisher, West Hartford, CT (US); Alexandru Cadar, Eastford, CT (US); Joshua M. Norman, South Windsor, CT (US)

(21) Appl. No.: 18/332,429

(22) Filed: Jun. 9, 2023

(51) Int. Cl. B22F 10/73; B22F 10/28; B22F 10/80; B29C 64/153; B29C 64/357; B29C 64/386; B33Y 10/00; B33Y 40/00; B33Y 50/00

(52) U.S. Cl. CPC B22F 10/73; B22F 10/28; B22F 10/80; B29C 64/153; B29C 64/357; B29C 64/386; B33Y 10/00; B33Y 40/00; B33Y 50/00

(57) ABSTRACT

A method for determining whether build powder is fit for reuse in a laser powder bed fusion additive manufacturing (LPBF) process includes constructing a model for determining a Powder Reuse Index indicative of whether build powder is fit for reuse in the LPBF process based upon LPBF process operating parameters. A build design is selected to be built using the LPBF process to collect data for constructing the model for determining the Powder Reuse Index. A plurality of test pieces the selected build design are built using a LPBF system with different layouts or set ups. Quality characteristics are determined for each of the plurality of test pieces and, using the quality characteristics for each of the plurality of test pieces, a relative importance of each LPBF process build parameter as to whether a batch of build powder is fit for reuse is determined.

### BACKGROUND

The present disclosure relates generally to laser powder bed fusion additive manufacturing and, more particularly, to a method of determining the quality of reused build powder.

Laser Powder bed fusion (LPBF) additive manufacturing is an additive manufacturing, or 3-D printing, technology that uses a laser to sinter or fuse metallic or polymeric particles together in a layer-by-layer process. LPBF is typically used as an industrial process to make near net shape parts. Some LPBF processes sinter the build powder particles, while others melt and fuse the build powder particles. LPBF is also known as direct metal laser sintering (DMLS).

Adding LPBF additive manufacturing techniques into the mix of manufacturing processes brings with it the challenge that build powder can be expensive. Reusing build powder can reduce cost as long as reused build powder is capable of making parts that meet quality specifications. Because used build powder endures heat stress over a number of cycles in a typical LPBF additive manufacturing process, resulting parts can fall out of material strength specifications with enough reuse. A key challenge is how to reuse build powder while continuing to produce parts that meet applicable quality specifications.

### SUMMARY

One aspect of this disclosure is directed to a method for determining whether build powder is fit for reuse in a laser powder bed fusion additive manufacturing (LPBF) process. A model for determining a Powder Reuse Index indicative of whether build powder is fit for reuse in the LPBF process is constructed based upon LPBF process operating parameters. A build design is selected to be built using the LPBF process to collect data for constructing the model for determining the Powder Reuse Index. A plurality of test pieces of the selected build designs is built using a LPBF system with different combinations layouts or set ups. Quality characteristics are determined for each of the plurality of test pieces and, using the quality characteristics for each of the plurality of test pieces, a relative importance of each LPBF process build parameter as to whether a batch of build powder is fit for reuse is determined.

Another aspect of the disclosure is directed to a Powder Reuse Index indicative of whether powder is fit for reuse in a laser powder bed fusion additive manufacturing (LPBF) process. The Powder Quality Index is computed using the following parameters: T_{b}, C1*TED, C2*V_{b}, C3*FR, C4*DR, C4*Vᵣ, C5*SAᵣ, C6*SAV, and C7*ED. In the formula, C1, C2, C3, C4, C4, C6, and C7 are statistical coefficients, T_{b} is a build plate temperature, TED is a total energy density, V_{b} is a build area volume, FR is a job fill rate, DR is an effective density ratio, Vᵣ is a volume ratio, SAᵣ is a surface area ratio, SAV is a surface area to volume ratio, and ED is an energy density.

Yet another aspect of this disclosure is directed to a method for additive manufacturing of a plurality of parts using a laser powder bed fusion additive manufacturing (LPBF) system. An initial batch of build powder is provided to the LPBF system and the initial batch of build powder in the LPBF system is used to build a first part. The first part is removed from the LPBF system and a Powder Reuse Index is determined for a remaining quantity of the build powder. The determined Powder Reuse Index is compared to a reference index to assess whether the remaining quantity of the build powder is fit for reuse in the LPBF process. If the remaining quantity of the build powder is fit for reuse in the LPBF process, the remaining quantity of the build powder is made available for reuse as reused build powder. The amount of the reused build powder is assessed to determine whether there is a sufficient amount of the reused build powder to support a next build in the LPBF system. If there is a sufficient amount of the reused build powder to support the next build in the LPBF system, the reused build powder is used for the next build in the LPBF system.

### BRIEF DESCRIPTION OF THE DRAWINGS

FIG. 1 is a schematic of an exemplary laser powder bed fusion (LPBF) additive manufacturing system.

FIG. 2 is photograph of a part made on a LPBF additive manufacturing system of FIG. 1 with loose remaining build powder.

FIG. 3 is a flow chart of a method for determining whether build powder is fit for reuse in a LPBF process.

FIG. 4 is a flow chart of a method for additive manufacturing a plurality of parts using a LPBF additive manufacturing system.

### DETAILED DESCRIPTION

Laser Powder bed fusion (LPBF) additive manufacturing is an option to make near net shape parts. The expense of build powder used in LPBF processes is a challenge to be addressed as LPBF is scaled up to make parts on an industrial scale. As is known, build powder used in a LPBF process is exposed to heat stress over multiple deposition and consolidation cycles. With enough reuse, parts made with reused build powder can fall out of material property specifications or can contain various defects. Quantifying the impact on part quality of reusing build powder is difficult because many variables, including build time, build geometry, and laser parameters, change between builds or even within the same build.

The present disclosure is directed to determining whether build powder is fit for reuse in a LPBF additive manufacturing process by developing a Powder Reuse Index. The Powder Reuse Index is based upon LPBF process operating parameters and assessment of the quality characteristics of a plurality of test pieces, each having different layouts or set ups. Using the Powder Reuse Index for a particular LPBF system, build powder remaining after a build operation can be assessed to determine if it is fit for reuse in the LPBF process for additional build operations without the need for repetitive testing after each build, which can cost money and time.

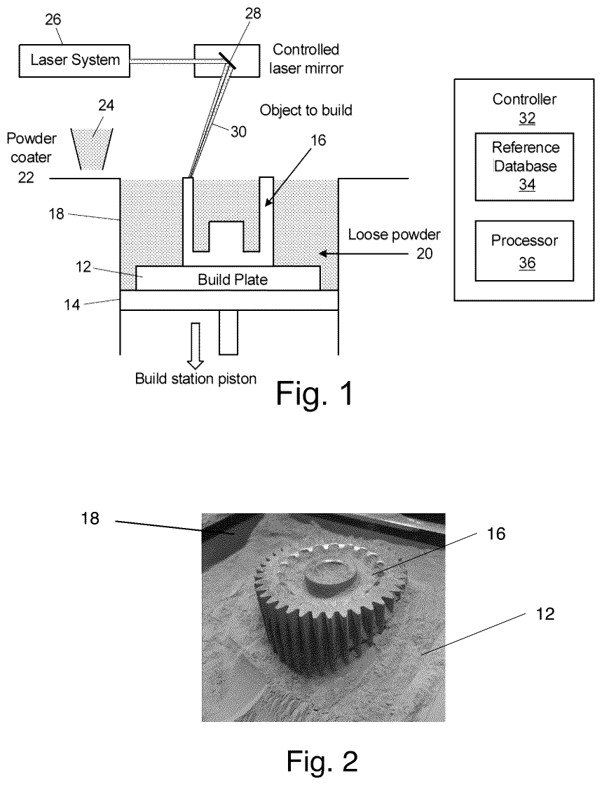

FIG. 1 is a schematic of an exemplary, non-limiting laser powder bed fusion additive manufacturing (LPBF) system 10. A typical LPBF system 10 includes a build plate 12, a build station piston 14 that adjusts the height of the build plate 12, a workpiece or part 16 that is built on top of the build plate 12, a powder chamber 18 to contain loose, and unconsolidated build powder 20 that surrounds the workpiece 16. A typical LPBF system 10 also includes a powder coater 22 that distributes additional build powder 24 over the workpiece 16 after completion of each layer formed on the workpiece 16. A laser system 26 combined with a controlled laser mirror 28 directs a laser beam 30 onto loose build powder 20 to form a melt pool (not shown) that, when solidified, forms a layer of the workpiece 16. As each layer of the workpiece 16 is formed, the build station piston 14 lowers the built plate 12 and workpiece 16 by a predetermined distance that corresponds to the desired thickness of the next layer of the workpiece 16. The powder coater 22 then moves across the top of the loose build powder 20 to distribute a layer of additional build powder 24 that will then be consolidated with the laser beam 30 to form the next layer of the workpiece 16.

Controller 32 controls the height of the build plate 12 by moving the build station piston 14, which in turn controls the thickness of each layer of the workpiece 16. Controller 32 also controls the movement of the powder coater 22 as it distributes additional build powder 24 and the movement of the laser beam 30 as it forms the melt pool that consolidates loose build powder 20 to form each layer of the workpiece 16. For example, the controller 32 controls LPBF system 10 operating parameters, including:
(1) laser beam power, velocity, and spot size, build plate temperature, and layer thickness;
(2) temperature-dependent thermophysical properties of the powder;
(3) feedstock properties including average powder particle size; and
(4) laser hatching strategy including hatch distance, hatch delay time, and stripe width.

Controller 32 typically includes a reference database 34 and processor 36. Reference database 34 contains processing data relevant to the LPBF system 10, build powder to be used to produce the workpiece 16, and the specific work piece 16 to be produced. Processor 36 contains programming to interface with the reference database 34 to control the LPBF system 10 to products parts, such as workpiece 16, as is known to a person of ordinary skill in the art. Workpiece 16 can be a near-net-shaped part (i.e., initial production of the part that is very close to the final (net) shape).

The LPBF system 10 can be used with a variety of build powders to produce workpiece 24. For example the powder can be a metal powder or polymeric powder. Metallic powders compatible with typical LPBF systems 10 include aluminum, aluminum alloys (e.g., aluminum-lithium alloys), titanium, nickel, nickel alloys, and other metals and alloys known in the art. Polymeric powders compatible with typical LPBF systems 10 include a wide variety of polymers as known in the art.

FIG. 2 is a photograph of a part or workpiece 16 made on LPBF system 10. FIG. 2 also shows powder chamber 18 that contains loose and unconsolidated build powder 20 remaining after the build operation used to make workpiece 16. The present disclosure is directed to developing a Powder Reuse Index to determine whether build powder remaining after a build operation is fit for reuse for another LPBF build operation.

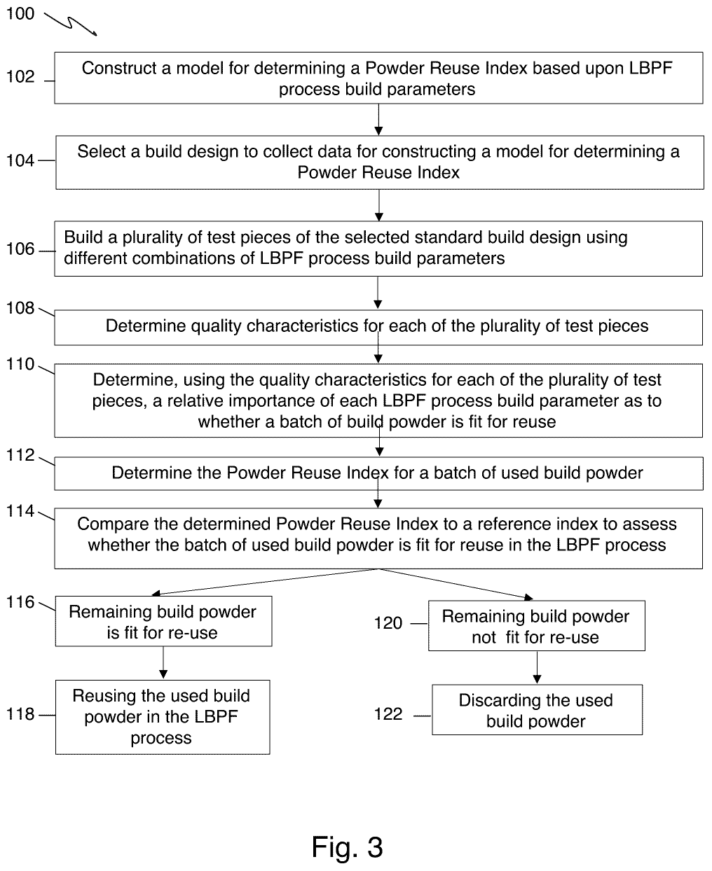

FIG. 3 is a flow chart of a method 100 for determining whether build powder is fit for reuse in a LPBF process. As a first step 102, a model for determining a Powder Reuse Index indicative of whether build powder is fit for reuse in the LPBF process is constructed based upon LPBF process operating parameters. The LPBF process operating parameters include one or more of:
a total volume of powder required for a complete build, including the volume to satisfy a recoat ratio, which reflects the addition powder used for each layer to provide sufficient powder for the layer (Vₚ);
a minimum cube size that encompasses an entire build; this is the minimum cube that is parallel to the x, y, & z axes of the build plate and encompasses the entire build (Vₑ);
a total volume of the build, including the total volume of the part geometry plus any supports and test specimens (Vₚₑ);
an total area available for a build, which is typically the area of the build plate (A_{b});
a minimum square that encompasses a single slice cross-sectional area of the build; the minimum square is parallel to the x and y axes of the build plate and encompass a single slice cross-sectional area (Aₛ);
an area of all closed curves in a single build slice (Aₓ);
a number of layers in the build (N_{L});
a build height (H);
a perimeter of a single build slice, which is the length of all closed curves in a single build slice (Lₕ);
a number of laser hours for the build (Lₕ);
a laser power setting for the build, which should be selected to reflect the overall power applied to the powder during a build; this could be the maximum laser power used for the build or another metric deemed appropriate for a particular application (P);
a laser velocity, which is the laser scan speed for the build (V);
a hatch spacing, which is the spacing between the mid-line of successive laser passes (HS);
a layer thickness for the build (t);
a build plate temperature (T_{b});
a surface area of a sphere with the same volume as a part or parts made during the build (SAₛₚₕₑᵣₑ);
a surface area of the part or parts made during the build (SAₚₐᵣₜ); and
a number of holes and cores within the part made during the build (N_{c}).
   Other operating parameters, including but not limited to a center of gravity and orientation of the build (i.e., a parameter to quantify location of build and orientation (CGO_{b})) can also be included among the operating parameter used for determining the Powder Reuse Index.

Next, at step 104 a build design to be built using the LPBF process is selected to collect data for constructing the model for determining the Powder Reuse Index. The build designs may any build design that the user determines to be appropriate to collect data for the model. For example, the build design may be selective to be representative of the types of parts for which the Powder Reuse Index will be calculated. While at least two build designs may be selected to provide a range of data to construct the model, the user may select any number of build designs (even just one build design) to provide a desired range of data.

At step 106, a plurality of test pieces of the selected build design are built using a LPBF system. Different combinations of layouts or set ups should be selected so the test pieces represent a range of anticipated processing parameters for the types of parts for which the Powder Reuse Index will be calculated. The process operating parameters include, but are not limited to, laser beam power, laser beam velocity, and laser beam spot size, build plate temperature, layer thickness, and laser hatching strategy including hatch distance, hatch delay time, and stripe width. The plurality of test pieces are made with the same initially loaded build powder until the quantity of build powder is insufficient to build more test pieces.

At step 108, quality characteristics for each of the plurality of test pieces are determined. The quality characteristics can include at least one of residual stress, microstructure, porosity, crack propensity, and mechanical properties of the build. Other characteristics can be considered a well. The selected quality characteristics can be determined using methods know in the art.

Using the quality characteristics for each of the plurality of test pieces, the relative importance of each LPBF process build parameter as to whether a batch of build powder is fit for reuse is determined at step 110.

Once the model for determine the Powder Reuse Index has been constructed, the model can be used following a build on a LPBF system. At step 112, the Powder Reuse Index for a batch of used build powder is determined and, at step 114 is compared reference index to assess whether the batch of used build powder is fit for reuse in the LPBF process. The reference index is the threshold of Powder Reuse Index below which the used build powder is deemed to be fit for reuse based on the testing performed and analyzed in steps 108 and 110. If, at step 116, the batch of used build powder is determined to be fit for reuse in the LPBF process, the used batch of build powder is reused in the LPBF process at step 118. If, at step 120, the batch of used build powder is determined not to be fit for reuse in the LPBF process, the used batch of build powder is discarded at step 122.

The Powder Reuse Index may be computed using a number of parameters, including but not limited to: T_{b}, C1*TED, C2*V_{b}, C3*FR, C4*DR, C4*Vᵣ, C5*SAᵣ, C6*SAV, and C7*ED. Depending on the application, more or fewer parameters may be used to compute the Power Reuse Index. In one, non-limiting example, the Powder Reuse Index may be computed using the following formula:

$$Index = {T}_{b} + C 1 * T E D + C 2 * {V}_{b} +$$

$$C 3 * FR + C 4 * DR + C 4 * {V}_{r} + C 5 * {SA}_{r} + C 6 * SAV +$$

$$C 7 * ED$$

For this computation:
C1, C2, C3, C4, C4, C6, and C7 are statistical coefficients that are determined using statistical methods based on data obtained from applying the Powder Reuse Index to test and production parts. If desired, the statistical coefficients can initially be set to 1 and then “tuned” based on experience gained from building test and production parts. For elements of the Powder Reuse Index determined not to be significant, the corresponding statistical coefficient can be set to 0;
T_{b} is the build plate temperature;
TED is a total energy density and is computed with the following formula:

$$∘ T E D = ( 3600 ⋆ {L}_{h} ⋆ P ) / {V}_{p} ;$$

V_{b} is a build area volume and is computed with the following formula:

$$∘ {V}_{b} = Ab ⋆ H ;$$

FR is a job fill rate and is computed with the following formula:

$$∘ FR = ( {V}_{pe} / {V}_{e} ) ⋆ 100 ;$$

DR is an effective density ratio and is computed with the following formula:

$$∘ DR = Σ [ {A}_{x} / ( {A}_{{b}^{-}} {A}_{x} ) ] / NL ;$$

Vᵣ is a volume ratio and is computed with the following formula:

$$∘ {V}_{r} = ( {V}_{p e} / ( {V}_{p} - {V}_{p e} ) ) ⋆ 100 ;$$

SAᵣ is a surface area ratio and is computed with the following formula:

$$∘ {S}_{ar} = Σ [ ( {P}_{x} ⋆ t ) / Ax ) ] ⋆ 100 ;$$

SAV is a surface area to volume ratio and is computed with the following formula:

$$∘ SAV = ( {ΣP}_{x} ⋆ t ) / ( {V}_{p} - {V}_{p e} ) \text{;;}$$

ED is an energy density and is computed with the following formula:

ED=P/(V*HS*t).

C1, C2, C3, C4, C4, C6, and C7 are determined using a statistical method to reflect the relative importance of a particular parameter in the context of a specific build using specific materials. For any particular Powder Reuse Index calculation, fewer or additional parameters can be included based on a specific build using specific materials.

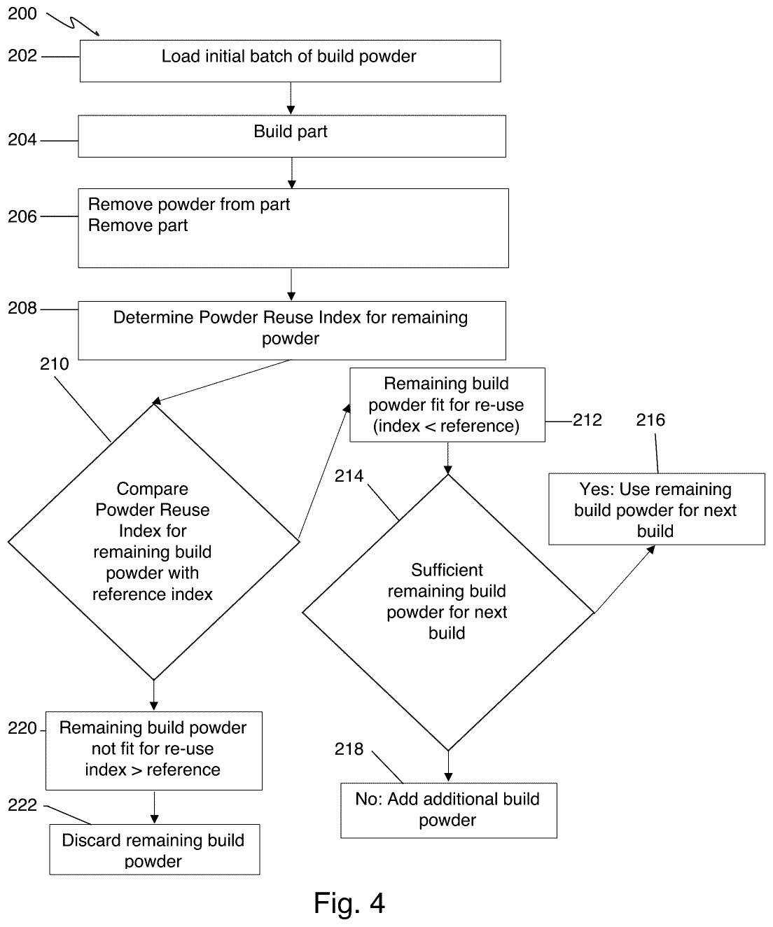

FIG. 4 is a flow chart of a method 200 for additive manufacturing a plurality of parts using a LPBF additive manufacturing system. As a first step 202, an initial batch of build powder is provided to the LPBF system. As discussed above, the build powder may be a metal or a metallic alloy or a polymeric material depending of the parts to be build. The initial batch of build powder may be unused build powder, reused build powder, or a combination of unused and reused build powder. The suitability of the reused build powder will have already been determined using the disclosed Powder Reuse Index.

Once the initial batch of build powder has been provided to the LPBF system, a first part is built at step 204 using selected LPBF system operating parameters using the batch of build powder in the LPBF system. The selected LPBF system operating parameters can include any desired combination of laser beam power, laser beam velocity, and laser beam spot size, build plate temperature, layer thickness, and laser hatching strategy including hatch distance, hatch delay time, and stripe width. Other LPBF system operating parameters can be selected as well. The first part can be a complex near-net-shaped part or any other part desired to be made using the LPBF system.

At step 206, powder is removed from the part using processes known in the art and the part is removed from the LPBF system. Depending on the type of LPBF system used to make the part and selected operating protocol, the build powder remaining in the LPBF system after removing the first part may itself be removed.

Regardless of whether the remaining build powder is removed or left in the LPBF system, a Powder Reuse Index for a remaining quantity of the build powder is determined at step 208 according to the method described above. At step 210, the determined Powder Reuse Index is compared to a reference index to assess whether the remaining quantity of the build powder is fit for reuse in the LPBF process. As discussed above, The reference index is the threshold of Powder Reuse Index beyond which the used build powder is deemed to be fit for reuse based on the testing performed and analyzed in steps 108 and 110 of FIG. 3.

If, at step 212, the remaining quantity of the build powder is deemed fit for reuse in the LPBF process, the remaining quantity of the build powder is made available for reuse as reused build powder. At step 214, the amount of reused build powder is assessed to determining whether there is a sufficient amount of the reused build powder to support a next build in the LPBF system. If there is a sufficient amount of the reused build powder to support the next build in the LPBF system, at step 216, the reused build powder is used for the next build in the LPBF system. If there is not a sufficient amount of the reused build powder to support the next build in the LPBF system, additional build powder can be added to the reused build powder for the next build in the LPBF system at step 218. If, at step 220, the remaining quantity of the build powder is deemed not fit for reuse in the LPBF process, the remaining quantity of the build powder is discarded at step 222.

The disclosed method allows used build powder to be characterized to determine its suitability for reuse without the need for repetitive testing after each build, which can cost money and time. Based on experience with particular builds and build powders, the Powder Reuse Index can be computed a limited number of times, or even once, and reused for similar builds and build powders. The method can lower the cost of making parts with a LPBF process by allowing its user to extract the highest number of “in-spec” parts from a single batch of new powder before any subsequent parts fall out of spec. This saves new powder cost, machine runtime, characterization costs, and machine downtime. In addition, the disclosed method can be used to characterize the powder used to manufacture a build lot to gain a better understanding of how the part was made and how it will perform.

### Discussion of Possible Embodiments

The following are non-exclusive descriptions of possible embodiments of the present invention.

A method for determining whether build powder is fit for reuse in a laser powder bed fusion additive manufacturing (LPBF) process comprises the steps of: constructing a model for determining a Powder Reuse Index indicative of whether build powder is fit for reuse in the LPBF process based upon LPBF process operating parameters; selecting at a build design to be built using the LPBF process to collect data for constructing the model for determining the Powder Reuse Index; building, using a LPBF system, a plurality of test pieces of the selected build design using different layouts or set ups; determining quality characteristics for each of the plurality of test pieces; and determining, using the quality characteristics for each of the plurality of test pieces, a relative importance of each LPBF process build parameter as to whether a batch of build powder is fit for reuse.

The method for determining whether build powder is fit for reuse of the preceding paragraph can optionally include, additionally and/or alternatively, any one or more of the following features, configurations and/or additional elements:

A further embodiment of the foregoing method for determining whether build powder is fit for reuse, wherein the quality characteristics include at least one of residual stress, microstructure, porosity, crack propensity and mechanical properties of the build.

A further embodiment of any of the foregoing method for determining whether build powder is fit for reuse, wherein the LPBF process operating parameters include one or more of a total volume of powder required for a complete build (Vₚ), a minimum cube size that encompasses an entire build (Vₑ), a total volume of the build (Vₚₑ), a center of gravity and orientation of the build (CGO_{b}), an total area available for a build (A_{b}), a minimum square that encompasses a single slice cross-sectional area of the build (Aₛ), an area of all closed curves in a single build slice (Aₓ), a number of layers in the build (N_{L}), a build height (H), a perimeter of a single build slice (Lₕ), a number of laser hours for the build (Lₕ), a laser power setting for the build (P), a laser velocity (V), a hatch spacing (HS), a layer thickness for the build (t), a build plate temperature (T_{b}), a surface area of a sphere with the same volume as a part made during the build (SAₛₚₕₑᵣₑ), a surface area of the part made during the build (SAₚₐᵣₜ), and a number of holes and cores within the part made during the build (N_{c}).

A further embodiment of the foregoing method for determining whether build powder is fit for reuse, wherein the Powder Reuse Index is computed using the following parameters: T_{b}, C1*TED, C2*V_{b}, C3*FR, C4*DR, C4*Vᵣ, C5*SAᵣ, C6*SAV and C7*ED and wherein: C1, C2, C3, C4, C4, C6, and C7 are statistical coefficients, T_{b} is the build plate temperature, TED is a total energy density. V_{b} is a build area volume, FR is a job fill rate, DR is an effective density ratio, Vᵣ is a volume ratio, SAᵣ is a surface area ratio, SAV is a surface area to volume ratio, and ED is an energy density; and the method further comprises the step of determining C1, C2, C3, C4, C4, C6, and C7 using a statistical method.

A further embodiment of the foregoing method for determining whether build powder is fit for reuse, wherein the Powder Reuse Index is computed using the following formulas:
TED is computed with the following formula: TED=(3600*Lₕ*P)/Vₚ;
V_{b} is computed with the following formula: V_{b}=A_{b}*H;
FR is computed with the following formula: FR=(Vₚₑ/Vₑ)*100;
DR is computed with the following formula: DR=Σ[Aₓ/(A_{b}-Aₓ)]/N_{L};
Vr is computed with the following formula: Vr=(Vpe/(Vp−Vpe))*100;
SAᵣ is computed with the following formula: SAᵣ=Σ[(Px*t)/Ax)]*100;
SAV is computed with the following formula: SAV=(ΣPx*t)/(Vp−Vpe); and
ED is computed with the following formula: ED=P/(V*HS*t).

A further embodiment of any of the foregoing method for determining whether build powder is fit for reuse, further comprising the steps of: determining the Powder Reuse Index for a batch of used build powder; comparing the determined Powder Reuse Index to a reference index to assess whether the batch of used build powder is fit for reuse in the LPBF process; if the batch of used build powder is fit for reuse in the LPBF process, reusing the used batch of build powder in the LPBF process; and if the batch of used build powder is not fit for reuse in the LPBF process, discarding the used batch of build powder.

A Powder Reuse Index indicative of whether powder is fit for reuse in a laser powder bed fusion additive manufacturing (LPBF) process, wherein the Powder Quality Index is computed using the following parameters: T_{b}, C1*TED, C2*V_{b}, C3*FR, C4*DR, C4*Vᵣ, C5*SAᵣ, C6*SAV, and C7*ED; wherein: C1, C2, C3, C4, C4, C6, and C7 are statistical coefficients, T_{b} is a build plate temperature, TED is a total energy density, V_{b} is a build area volume, FR is a job fill rate, DR is an effective density ratio, Vᵣ is a volume ratio, SAᵣ is a surface area ratio, SAV is a surface area to volume ratio, and ED is an energy density.

A further embodiment of the foregoing Powder Reuse Index, wherein the Powder Reuse Index is based upon LPBF process operating parameters and the LPBF process operating parameters include one or more of a total volume of powder required for a complete build (Vₚ), a minimum cube size that encompasses an entire build (Vₑ), a total volume of the build (Vₚₑ), a center of gravity and orientation of the build (CGO_{b}), an total area available for a build (A_{b}), a minimum square that encompasses a single slice cross-sectional area of the build (Aₛ), an area of all closed curves in a single build slice (Aₓ), a number of layers in the build (N_{L}), a build height (H), a perimeter of a single build slice (Lₕ), a number of laser hours for the build (Lₕ), a laser power setting for the build (P), a laser velocity (V), a hatch spacing (HS), a layer thickness for the build (t), a build plate temperature (T_{b}), a surface area of a sphere with the same volume as a part made during the build (SAₛₚₕₑᵣₑ), a surface area of the part made during the build (SAₚₐᵣₜ), and a number of holes and cores within the part made during the build (Nₑ).

A further embodiment of the foregoing Powder Reuse Index, wherein:
TED is computed with the following formula: TED=(3600*Lₕ*P)/Vₚ;
Vb is computed with the following formula: Vb=Ab*H;
FR is computed with the following formula: FR=(Vpe/Ve)*100;
DR is computed with the following formula: DR=Σ[Ax/(Ab−Ax)]/NL;
Vr is computed with the following formula: Vr=(Vpe/(Vp−Vpe))*100;
Sar is computed with the following formula: Sar=Σ[(Px*t)/Ax)]*100
SAV is computed with the following formula: SAV=(ΣPx*t)/(Vp−Vpe); and
ED is computed with the following formula: ED=P/(V*HS*t).

A method for additive manufacturing of a plurality of parts using a laser powder bed fusion additive manufacturing (LPBF) system, comprising: providing an initial batch of build powder to the LPBF system; building, using the initial batch of build powder in the LPBF system, a first part; removing the first part from the LPBF system; determining a Powder Reuse Index for a remaining quantity of the build powder; comparing the determined Powder Reuse Index to a reference index to assess whether the remaining quantity of the build powder is fit for reuse in the LPBF process; if the remaining quantity of the build powder is fit for reuse in the LPBF process, making the remaining quantity of the build powder available for reuse as reused build powder; determining whether there is a sufficient amount of the reused build powder to support a next build in the LPBF system; and if there is a sufficient amount of the reused build powder to support the next build in the LPBF system, using the reused build powder for the next build in the LPBF system.

A further embodiment of the foregoing method for additive manufacturing of a plurality of parts, wherein the an initial batch of build powder is unused build powder.

A further embodiment of the foregoing method for additive manufacturing of a plurality of parts, wherein the an initial batch of build powder is reused build powder.

A further embodiment any of the foregoing methods for additive manufacturing of a plurality of parts, wherein building, using the batch of build powder in the LPBF system, a first part comprises using LPBF system operating parameters, including: laser beam power, laser beam velocity, and laser beam spot size, build plate temperature, layer thickness, and laser hatching strategy including hatch distance, hatch delay time, and stripe width.

A further embodiment any of the foregoing methods for additive manufacturing of a plurality of parts, wherein the first part is a complex near-net-shaped part.

A further embodiment any of the foregoing methods for additive manufacturing of a plurality of parts, wherein the part is produced from a metal or a metallic alloy.

A further embodiment any of the foregoing methods for additive manufacturing of a plurality of parts, wherein the part is produced from a polymeric material.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for determining whether build powder is fit for reuse in a laser powder bed fusion additive manufacturing (LPBF) process, comprising the steps of:
constructing a model for determining a Powder Reuse Index indicative of whether build powder is fit for reuse in the LPBF process based upon LPBF process operating parameters;
selecting at a build design to be built using the LPBF process to collect data for constructing the model for determining the Powder Reuse Index;
building, using a LPBF system, a plurality of test pieces of the selected build design using different layouts or set ups;
determining quality characteristics for each of the plurality of test pieces; and
determining, using the quality characteristics for each of the plurality of test pieces, a relative importance of each LPBF process build parameter as to whether a batch of build powder is fit for reuse.

2. The method of claim 1, wherein the quality characteristics include at least one of residual stress, microstructure, porosity, crack propensity and mechanical properties of the build.

3. The method of claim 1, wherein the LPBF process operating parameters include one or more of a total volume of powder required for a complete build (Vₚ), a minimum cube size that encompasses an entire build (Vₑ), a total volume of the build (Vₚₑ), a center of gravity and orientation of the build (CGO_{b}), an total area available for a build (A_{b}), a minimum square that encompasses a single slice cross-sectional area of the build (Aₛ), an area of all closed curves in a single build slice (Aₓ), a number of layers in the build (N_{L}), a build height (H), a perimeter of a single build slice (Lₕ), a number of laser hours for the build (Lₕ), a laser power setting for the build (P), a laser velocity (V), a hatch spacing (HS), a layer thickness for the build (t), a build plate temperature (T_{b}), a surface area of a sphere with the same volume as a part made during the build (SAₛₚₕₑᵣₑ), a surface area of the part made during the build (SAₚₐᵣₜ), and a number of holes and cores within the part made during the build (Nₑ).

4. The method of claim 3, wherein the Powder Reuse Index is computed using the following parameters: Tb, C1*TED, C2*Vb, C3*FR, C4*DR, C4*Vr, C5*SAr, C6*SAV, and C7*ED wherein: C1, C2, C3, C4, C4, C6, and C7 are statistical coefficients, T_{b} is the build plate temperature, TED is a total energy density, V_{b} is a build area volume, FR is a job fill rate, DR is an effective density ratio, Vᵣ is a volume ratio, SAᵣ is a surface area ratio, SAV is a surface area to volume ratio, and ED is an energy density; and the method further comprises the step of determining C1, C2, C3, C4, C4, C6, and C7 using a statistical method.

5. The method of claim 4, wherein the Powder Reuse Index is computed using the following formulas:
TED is computed with the following formula: TED=(3600*Lₕ*P)/Vₚ;
V_{b} is computed with the following formula: V_{b}=A_{b}*H;
FR is computed with the following formula: FR=(Vₚₑ/Vₑ)*100;
DR is computed with the following formula: DR=Σ[Aₓ/(A_{b}−Aₓ)]/N_{L};
Vᵣ is computed with the following formula: Vᵣ=(Vₚₑ/(Vₚ−Vₚₑ))*100;
Sₐᵣ is computed with the following formula: Sₐᵣ=Σ[(Pₓ*t)/Aₓ)] *100;
SAV is computed with the following formula: SAV=(ΣPₓ*t)/(Vₚ−Vₚₑ); and
ED is computed with the following formula: ED=P/(V*HS*t).

6. The method of claim 1, further comprising the steps of:
determining the Powder Reuse Index for a batch of used build powder;
comparing the determined Powder Reuse Index to a reference index to assess whether the batch of used build powder is fit for reuse in the LPBF process;
if the batch of used build powder is fit for reuse in the LPBF process, reusing the used batch of build powder in the LPBF process; and
if the batch of used build powder is not fit for reuse in the LPBF process, discarding the used batch of build powder.

7. A Powder Reuse Index indicative of whether powder is fit for reuse in a laser powder bed fusion additive manufacturing (LPBF) process, wherein the Powder Quality Index is computed using the following parameters:
T_{b}, C1*TED, C2*V_{b}, C3*FR, C4*DR, C4*Vᵣ, C5*SAᵣ, C6*SAV, and C7*ED
wherein: C1, C2, C3, C4, C4, C6, and C7 are statistical coefficients, T_{b} is a build plate temperature, TED is a total energy density, V_{b} is a build area volume, FR is a job fill rate, DR is an effective density ratio, Vᵣ is a volume ratio, SAᵣ is a surface area ratio, SAV is a surface area to volume ratio, and ED is an energy density.

8. The Powder Reuse Index of claim 7, wherein the Powder Reuse Index is based upon LPBF process operating parameters and the LPBF process operating parameters include one or more of a total volume of powder required for a complete build (Vₚ), a minimum cube size that encompasses an entire build (Vₑ), a total volume of the build (Vₚₑ), a center of gravity and orientation of the build (CGO_{b}), an total area available for a build (A_{b}), a minimum square that encompasses a single slice cross-sectional area of the build (Aₛ), an area of all closed curves in a single build slice (Aₓ), a number of layers in the build (N_{L}), a build height (H), a perimeter of a single build slice (Lₕ), a number of laser hours for the build (Lₕ), a laser power setting for the build (P), a laser velocity (V), a hatch spacing (HS), a layer thickness for the build (t), a build plate temperature (T_{b}), a surface area of a sphere with the same volume as a part made during the build (SAₛₚₕₑᵣₑ), a surface area of the part made during the build (SAₚₐᵣₜ), and a number of holes and cores within the part made during the build (N_{c}).

9. The Powder Reuse Index of claim 8, wherein:
TED is computed with the following formula: TED=(3600*Lₕ*P)/Vₚ;
V_{b} is computed with the following formula: V_{b}=Ab*H;
FR is computed with the following formula: FR=(Vₚₑ/Vₑ)*100;
DR is computed with the following formula: DR=Σ[Aₓ/(A_{b}−Aₓ)]/NL;
Vᵣ is computed with the following formula: Vᵣ=(Vₚₑ/(Vₚ−Vₚₑ))*100;
Sₐᵣ is computed with the following formula: Sₐᵣ=Σ[(Pₓ*t)/Ax)] *100
SAV is computed with the following formula: SAV=(ΣPₓ*t)/(Vₚ−Vₚₑ); and
ED is computed with the following formula: ED=P/(V*HS*t).

10. A method for additive manufacturing of a plurality of parts using a laser powder bed fusion additive manufacturing (LPBF) system, comprising:
providing an initial batch of build powder to the LPBF system;
building, using the initial batch of build powder in the LPBF system, a first part;
removing the first part from the LPBF system;
determining a Powder Reuse Index for a remaining quantity of the build powder;
comparing the determined Powder Reuse Index to a reference index to assess whether the remaining quantity of the build powder is fit for reuse in the LPBF process;
if the remaining quantity of the build powder is fit for reuse in the LPBF process, making the remaining quantity of the build powder available for reuse as reused build powder;
determining whether there is a sufficient amount of the reused build powder to support a next build in the LPBF system; and
if there is a sufficient amount of the reused build powder to support the next build in the LPBF system, using the reused build powder for the next build in the LPBF system.

11. The method of claim 10, wherein the an initial batch of build powder is unused build powder.

12. The method of claim 10, wherein the an initial batch of build powder is reused build powder.

13. The method of claim 10, wherein building, using the batch of build powder in the LPBF system, a first part comprises using LPBF system operating parameters, including: laser beam power, laser beam velocity, and laser beam spot size, build plate temperature, layer thickness, and laser hatching strategy including hatch distance, hatch delay time, and stripe width.

14. The method of claim 10, wherein the first part is a complex near-net-shaped part.

15. The method of claim 10, wherein the part is produced from a metal or a metallic alloy.

16. The method of claim 10, wherein the part is produced from a polymeric material.
